(19) United States
(12) Patent Application Publication
(10) Pub. No.: US 2015/0154213 A1
(43) Pub. Date: Jun. 4, 2015

(54) INFORMATION PROCESSING METHOD AND ELECTRONIC DEVICE

(71) Applicants: Lenovo (Beijing) Limited, Beijing (CN); Beijing Lenovo Sofware Ltd., Beijing (CN)

(72) Inventors: Jiuru Tang, Beijing (CN); Nalei Zhang, Beijing (CN); Wenfeng Wang, Beijing (CN); Hui Pan, Beijing (CN)

(21) Appl. No.: 14/458,728

(22) Filed: Aug. 13, 2014

(30) Foreign Application Priority Data
Dec. 2, 2013 (CN) 201310637232.3

(51) Int. Cl. G06F 17/30

(52) U.S. Cl. CPC G06F 17/30091; G06F 17/30017; G06F 17/30082

(57) ABSTRACT

Disclosed is an information processing method and an electronic device. The method comprises: determining K folders satisfying a preset condition and changing a display property of each of the K folders; and changing, when at least one of the K folders is opened using a first application, a display policy for the at least one folder. The present disclosure provides a filtering mechanism for user data which is capable of addressing the inconvenience in data processing due to display of all the data when the electronic device has a large amount of data, and improves user experience.

### CROSS-REFERENCE TO RELATED APPLICATION

This application claims priority under 35 U.S.C. 119 to the Chinese Patent Application No. 201310637232.3, filed on Dec. 2, 2013, entitled “Information Processing Method and Electronic Device”, which application is incorporated herein by reference in its entirety.

### TECHNICAL FIELD

The present disclosure relates to information processing, and more particularly, to information processing methods and electronic devices.

### BACKGROUND

Typically, an electronic device has a data display function for displaying data including video, image and audio files on a screen, such that a user can operate, such as manipulate, save, copy, move and delete, the data in the electronic device. Hence, data management in the electronic device can be facilitated and the user experience can be improved.

The conventional data display function displays all the data in the electronic device. As the electronic device is used by the user and has more and more data stored therein, it may be inconvenient for the user to operate the data if all of a large quantity of data is displayed. This may lead to a degraded user experience.

### SUMMARY

Embodiments of the present disclosure provide an information processing method and an electronic device, which are capable of addressing the inconvenience in data processing due to display of all the data, and thus improving user experience.

The above object is achieved by providing the following embodiments according to the present disclosure.

According to an aspect, an information processing method in an electronic device comprising a display unit and having M folders for storing multimedia files is provided. The method includes: determining, from the M folders, K folders that satisfy a preset condition, and changing a display property of each of the K folders, wherein M and K are non-negative integers and K<M; and when at least one of the K folders is opened using a first application, changing a display policy for the at least one folder.

According to another aspect, an electronic device is provided. The electronic device has M folders for storing multimedia files. The electronic device includes: a setting unit configured to determine, from the M folders, K folders that satisfy a preset condition, and change a display property of each of the K folders, where M and K are non-negative integers and K<M; and a display unit configured to change, when at least one of the K folders is opened using a first application, a display policy for the at least one folder.

The present disclosure provides the information processing method and the electronic device, in which K folders satisfying a preset condition are determined, and a display property of each of the K folders is changed. When at least one of the K folders is opened using a first application, a display policy for the at least one folder is changed. In this way, a filtering mechanism for user data is provided capable of filtering out any folder whose display is unnecessary. It is thus possible to address the inconvenience in data processing due to display of all the data, thereby improving user experience.

### BRIEF DESCRIPTION OF THE DRAWINGS

In order to illustrate the solutions according to the embodiments of the present application or the prior art in further detail, the figures used for description of the embodiments or the prior art will be introduced briefly here. It is apparent to those skilled in the art that the figures described below only illustrate some embodiments of the present disclosure and other figures can be obtained from the figures introduced below without applying any inventive skills.

FIG. 1 is a schematic flowchart illustrating an information processing method according to an embodiment of the present disclosure;

FIG. 2 is a schematic flowchart illustrating an information processing method according to an embodiment of the present disclosure;

FIG. 3 is a schematic diagram illustrating an information processing method according to an embodiment of the present disclosure;

FIG. 4 is a schematic diagram illustrating an information processing method according to an embodiment of the present disclosure;

FIG. 5 is a schematic diagram illustrating an information processing method according to an embodiment of the present disclosure;

FIG. 6 is a schematic flowchart illustrating an information processing method according to an embodiment of the present disclosure;

FIG. 7 is a schematic diagram illustrating an information processing method according to an embodiment of the present disclosure;

FIG. 8 is a schematic diagram illustrating an information processing method according to an embodiment of the present disclosure;

FIG. 9 is a schematic diagram illustrating an information processing method according to an embodiment of the present disclosure;

FIG. 10 is a schematic diagram illustrating an information processing method according to an embodiment of the present disclosure;

FIG. 11 is a schematic diagram illustrating an information processing method according to an embodiment of the present disclosure;

FIG. 12 is a schematic diagram showing an effect of an information processing method according to an embodiment of the present disclosure;

FIG. 13 is a schematic diagram showing an effect of an information processing method according to an embodiment of the present disclosure;

FIG. 14 is a schematic diagram showing a structure of an electronic device according to an embodiment of the present disclosure;

FIG. 15 is a schematic diagram showing a structure of an electronic device according to an embodiment of the present disclosure;

FIG. 16 is a schematic diagram showing a structure of an electronic device according to an embodiment of the present disclosure;

FIG. 17 is a schematic diagram showing a structure of an electronic device according to an embodiment of the present disclosure; and

FIG. 18 is a schematic diagram showing a structure of an electronic device according to an embodiment of the present disclosure.

### DETAILED DESCRIPTION OF THE EMBODIMENTS

In the following, the solutions according to the embodiments of the present disclosure will be described clearly and fully with reference to the figures. Obviously, the embodiments described below are only some, rather than all, of the embodiments. Starting from the embodiments of the present disclosure, those skilled in the art can obtain other embodiments with applying any inventive skills. All these embodiments are to be encompassed by the scope of the present disclosure.

The present disclosure provides an information processing method. The method is applied in an electronic device including a display unit and having M folders for storing multimedia files. As shown in FIG. 1, the method includes the following steps.

At step 101, K folders satisfying a preset condition are determined, and a display property of each of the K folders is changed, where M and K are non-negative integers and K<M.

At step 102, when at least one of the K folders is opened using a first application, a display policy for the at least one folder is changed.

The present disclosure provides an information processing method. K folders satisfying a preset condition are determined, and a display property of each of the K folders is changed. When at least one of the K folders is opened using a first application, a display policy for the at least one folder is changed. In this way, a filtering mechanism for user data is provided capable of filtering out any folder whose display is unnecessary. It is thus possible to address the inconvenience in data processing due to display of all the data, thereby improving user experience.

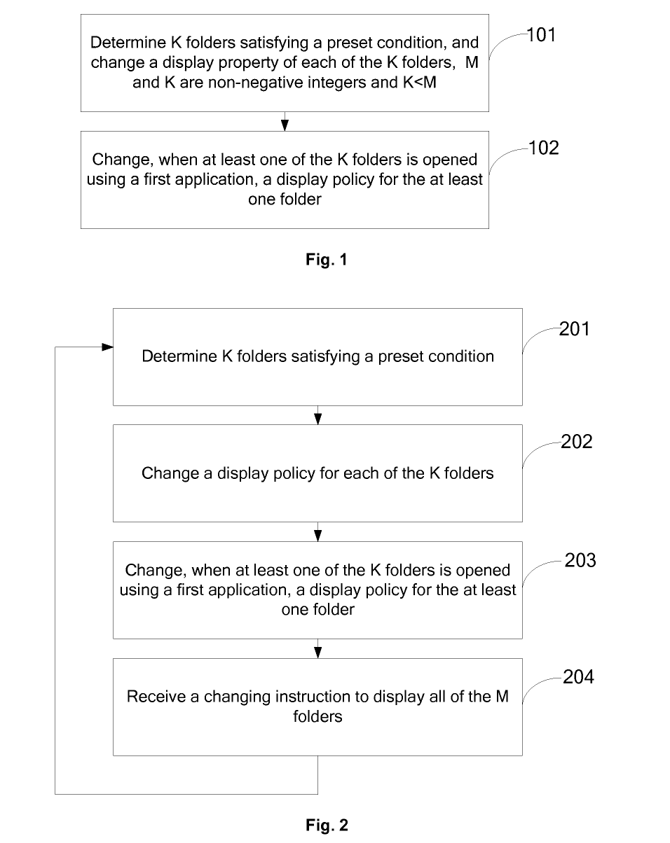

In order to allow those skilled in the art to understand the solutions of the present disclosure clearly, an information processing method according to an embodiment of the present disclosure will be described in detail with reference to specific embodiments. The method according to this embodiment is applied in an electronic device including a display unit and having M folders for storing multimedia files. As shown in FIG. 2, the method includes the following steps.

At step 201, K folders satisfying a preset condition are determined, where M and K are non-negative integers and K<M.

In an example, assuming that M has a value of 5, i.e., the electronic device has five folders, A, B, C, D and E, as shown in FIG. 3, a name of each of these folders A, B, C, D and E may be obtained as shown in Table 1.

TABLE 1

| Folder | Folder Name |
|---|---|
| Folder A | cache |
| Folder B | system |
| Folder C | html |
| Folder D | temp |
| Folder E | picture |

Preset keywords may include cache, system, html and temp. The preset keywords in this embodiment is exemplary only and the present disclosure is not limited thereto.

The names of the M folders are compared with the preset keywords. Since the preset keywords include cache, system, html and temp, four folders, Folder A, Folder B, Folder C and Folder D are determined as folders satisfying the preset condition. That is, K has a value of 4 in this case.

Alternatively, a use frequency of each of the folders A, B, C, D and E may be obtained first, as shown in Table 2.

TABLE 2

| Folder | Use Frequency of Folder |
|---|---|
| Folder A | Use Frequency 1 |
| Folder B | Use Frequency 2 |
| Folder C | Use Frequency 1 |
| Folder D | Use Frequency 1 |
| Folder E | Use Frequency 3 |

Alternatively, a number of timers that each of the folders A, B, C, D and E has been used may be obtained, as shown in Table 3.

TABLE 3

| Folder | Use Number of Folder |
|---|---|
| Folder A | Use Number 1 |
| Folder B | Use Number 2 |
| Folder C | Use Number 1 |
| Folder D | Use Number 1 |
| Folder E | Use Number 3 |

Alternatively, the folders that have been selected by a user operation as non-display may be obtained, as shown in Table 4.

TABLE 4

| Folder | Selected to be non-display |
|---|---|
| Folder A | Non-display |
| Folder B | Non-display |
| Folder C | Non-display |
| Folder D | Non-display |
| Folder E | |

Here, if the use frequency of each of the folder A, B, C, D and E is obtained, and Use Frequency 1 and Use Frequency 2 are lower than the preset frequency threshold, and Use Frequency 3 is higher than the preset frequency threshold, the four folders, Folder A, Folder B, Folder C and Folder D are determined as folders satisfying the preset condition.

Alternatively, if the number of timers that each of the folders A, B, C, D and E has been used is obtained, and Use Time 1 and Use Time 2 are smaller than the preset number threshold, and Use Time 3 is larger than the preset number threshold, the four folders, Folder A, Folder B, Folder C and Folder D are determined as folders satisfying the preset condition.

Alternatively, if the folders that is selected by a user operation as non-display are obtained, the four folders, Folder A, Folder B, Folder C and Folder D are determined as folders satisfying the preset condition.

At step 202, the display property of each of the K folders is changed.

In particular, the display property of each of the K folders (i.e., Folder A, Folder B, Folder C and Folder D) may be set as hidden.

Alternatively, a chroma value in the display property of each of the K folders (i.e., Folder A, Folder B, Folder C and Folder D) may be set as a first chroma value. Here, the first chroma value may be a chroma value by which the folders are displayed in a gray color, and a second chroma value may be a default chroma value used in the system before the setting.

At step 203, when at least one of the K folders is opened using a first application, a display policy for the at least one folder is changed.

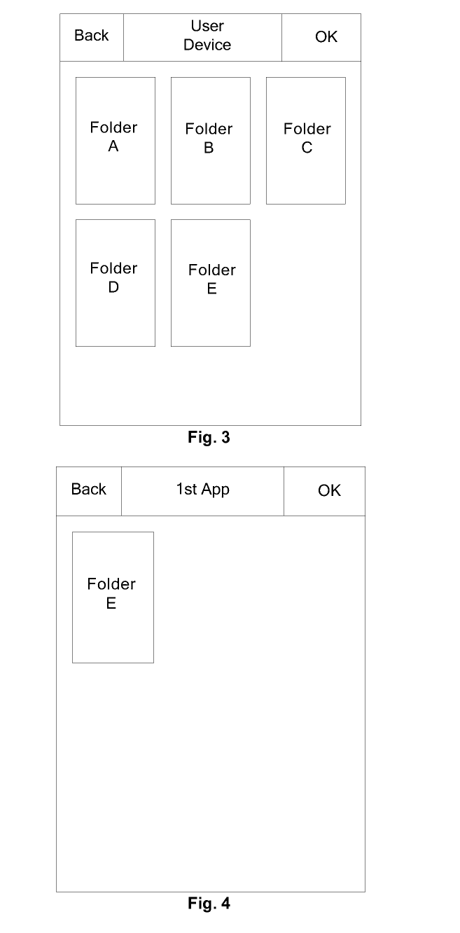

In particular, if the display property of each of the K folders has been set as hidden, when Folder B, Folder C and Folder E are opened using the first application, Folder E is displayed and Folder B and Folder C are not displayed, as shown in FIG. 4.

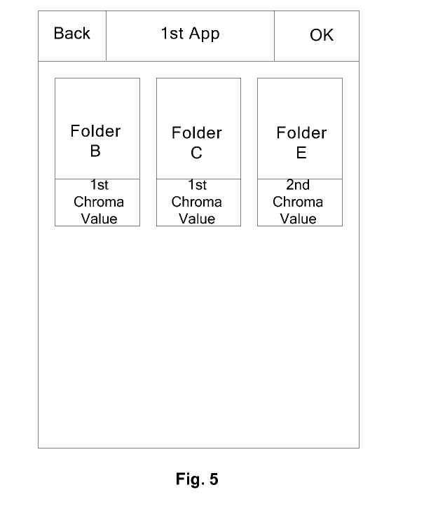

If the chroma value in the display property of each of the K folders has been set as the first chroma value, when Folder B, Folder C and Folder E are opened using the first application, Folder B and Folder C are displayed at the first chroma value, and Folder E is displayed at the second chroma value, as shown in FIG. 5.

Here, the second chroma value may be a default chroma value used in the system before the setting. The terms “first” and “second” are used here for distinguishing the two chroma values from each other, rather than indicating any particular chroma values.

The first application is exemplary only. It may be e.g., a file edition application and the present disclosure is not limited thereto.

At step 204, a changing instruction is received from a user operation to display all of the M folders.

In particular, according to the changing instruction, all of the M folders are displayed, as shown in FIG. 3. The method then proceeds to step 201 and the subsequent steps.

The present disclosure provides an information processing method. K folders satisfying a preset condition are determined, and a display property of each of the K folders is changed. When at least one of the K folders is opened using a first application, a display policy for the at least one folder is changed. In this way, a filtering mechanism for user data is provided capable of addressing the inconvenience in data processing due to display of all the data when the electronic device has a large amount of data, thereby improving user experience.

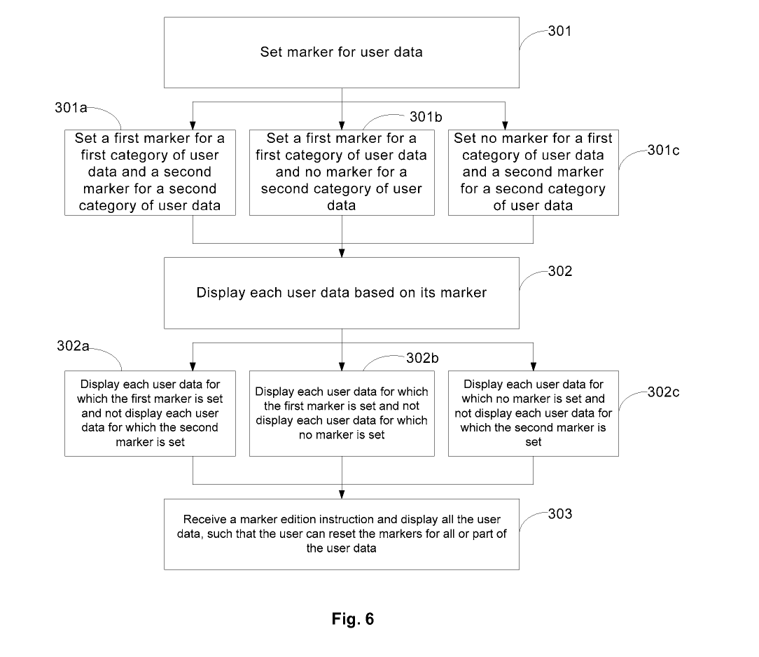

According to another embodiment, another information processing method is provided. As shown in FIG. 6, the method includes the following steps.

At step 301, a marker is set for user data.

In particular, the user data as used herein may refer to a single data item or a set of data items. As an example, a single data item may be a file such as an image, an audio file, a video file or a program; and a set of data items may be a folder which may include one or more images, audio files, video files and programs.

In an embodiment, a marker may be set for a file or a folder. If a marker is set for a file, the file is to be displayed in accordance with the set marker. If a marker is set for a folder, all the files in the folder are to be displayed in accordance with the marker for the folder.

A detail description will be given with reference to an example associated with an image file. Conventional image systems (or image browsers) typically display all the images in the electronic device. However, it is unnecessary to display some of the images, such as cache images for programs or images related to user privacy. Hence, markers may be set to distinguish these images.

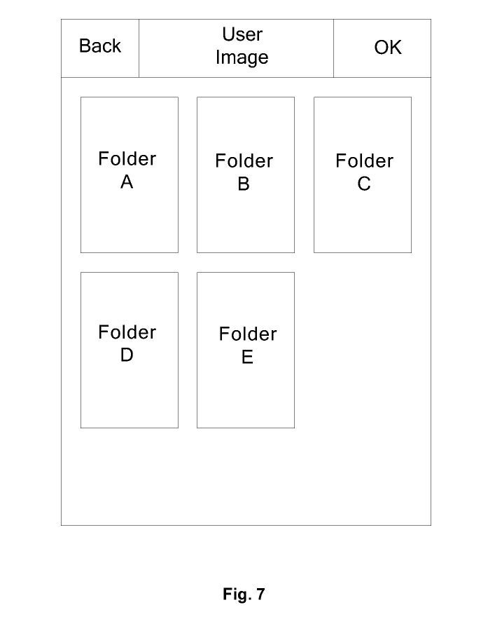

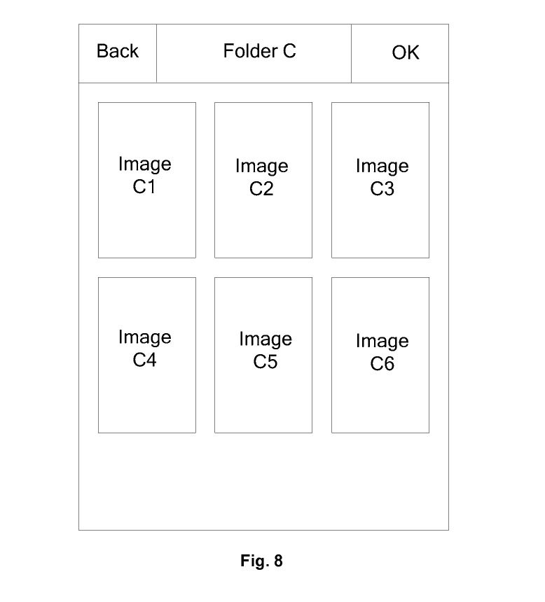

It is assumed that there are five folders, Folder A, Folder B, Folder C, Folder D and Folder E, in the electronic device, as shown in FIG. 7. Here, Folder C contains six image files, C1-C6, as shown in FIG. 8.

It is further assumed that Folder A, Folder C and Folder E as well as the image files C1, C2, C5 and C6 in Folder C belong to a first category of user data which needs to be displayed. The first category of user data may include user data that has a use frequency higher than or equal to a preset frequency threshold, or use data that has been used for a number of times larger than a preset number threshold, or use data that has been set to be displayed by default during initialization, or user data that has been selected by a user operation to be displayed.

Folder B, Folder D and the image files C3 and C4 in Folder C belong to a second category of user data which do not need to be displayed. The second category of user data may include user data that has a use frequency lower than a preset frequency threshold, use data that has been used for a number of times smaller than a preset number threshold, or use data that has been set not to be displayed by default during initialization, or user data that has been prohibited from being displayed by a user operation.

Here, the frequency threshold and the number threshold may be preset in the electronic device or may be set via a user operation.

In particular, each of three approaches, 301a-301c, may be used for setting a marker for user data.

In the approach 301a, a marker is set for each category of user data. Here, a first marker is set for the first category of user data, and a second marker is set for the second category of user data.

As an example, the first marker is set for Folder A, the second marker is set for Folder B, and the first marker is set for Folder C. In Folder C, the first marker is set for each of C1, C2, C5 and C6 and the second marker is set for each of C3 and C4. The second marker is set for Folder D, and the first marker is set for Folder E.

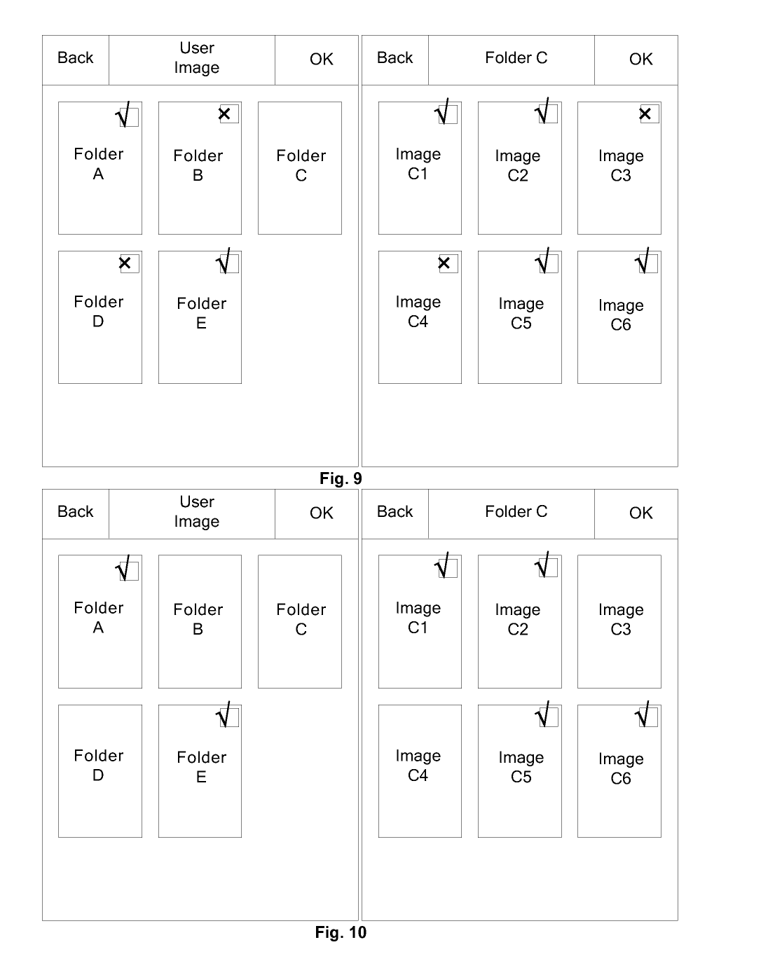

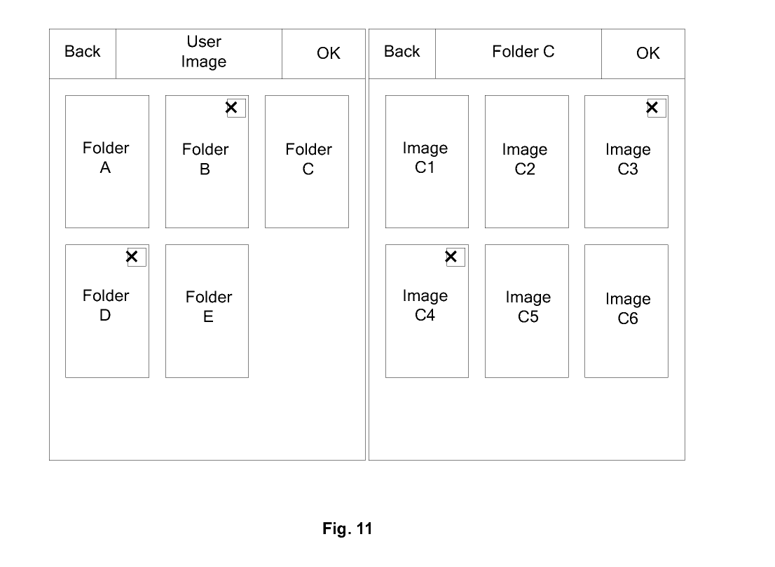

For example, as shown in FIG. 9, a marker “√” may be set for Folder A, C1, C2, C5 and C6 in Folder C, and Folder E; and a marker “X” may be set for Folder B, C3 and C4 in Folder C, and Folder D.

In the approach 301b, a first marker is set for the first category of user data, and no marker is set for the second category of user data.

As an example, the first marker is set for Folder A, no marker is set for Folder B, and the first marker is set for Folder C. In Folder C, the first marker is set for each of C1, C2, C5 and C6, and no marker is set for each of C3 and C4. No marker is set for Folder D, and the first marker is set for Folder E.

For example, as shown in FIG. 9, a marker “√” may be set for Folder A, C1, C2, C5 and C6 in Folder C, and Folder E; and no marker is set for Folder B, C3 and C4 in Folder C, and Folder D.

In the approach 301c, no marker is set for the first category of user data, and a second marker is set for the second category of user data.

As an example, no marker is set for Folder A, the second marker is set for Folder B, and no marker is set for Folder C. In Folder C, no marker is set for each of C1, C2, C5 and C6, and the second marker is set for each of C3 and C4. The second marker is set for Folder D, and no marker is set for Folder E.

For example, as shown in FIG. 9, no marker is set for Folder A, C1, C2, C5 and C6 in Folder C, and Folder E; and a marker “X” may be set for Folder B, C3 and C4 in Folder C, and Folder D.

The terms “first” and “second” in “the first marker” and “the second marker” are used here for distinguishing these markers from each other, rather than indicating any particular marker or any serial number of these markers.

As another example, in an embodiment of the present disclosure, the first marker may be “frequently used,” and the second marker may be “infrequently used”. Alternatively, the first marker may be “to be displayed,” and the second marker may be “not to be displayed”.

At step 302, each of the user data is displayed based on its marker.

In particular, a step 302a may be performed following the step 301a.

At 302a, each of the user data for which the first marker is set is displayed, and each of the user data for which the second marker is set is not displayed.

In an example, the first marker is set for Folder A, the second marker is set for Folder B and the first marker is set for Folder C. In Folder C, the first marker is set for each of C1, C2, C5 and C6 and the second marker is set for each of C3 and C4. The second marker is set for Folder D and the first marker is set for Folder E. Hence, Folder A, Folder C, Folder E and the image files C1, C2, C5 and C6 in Folder C are displayed and Folder B, Folder D and the image files C3 and C4 are not displayed. The other folders or files may or may not be displayed.

Alternatively, a step 302b may be performed following the step 301b.

At 302b, each of the user data for which the first marker is set is displayed, and each of the user data for which no marker is set is not displayed.

The display result is the same as that in 302a and the description thereof will thus be omitted here.

Alternatively, a step 302c may be performed following the step 301c.

At 302c, each of the user data for which no marker is set is displayed, and each of the user data for which the second marker is set is not displayed.

The display result is the same as that in 302a and the description thereof will thus be omitted here.

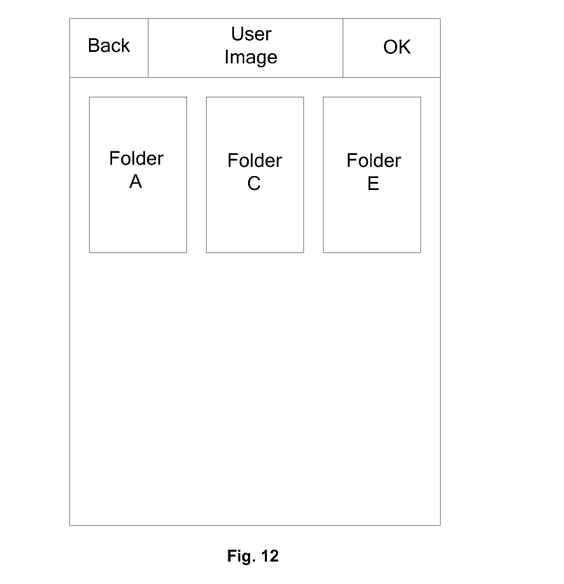

With the above process, the following display result will be obtained. In the image display system, Folder A, Folder C and Folder E are displayed, and Folder B and Folder D are not displayed, as shown in FIG. 12.

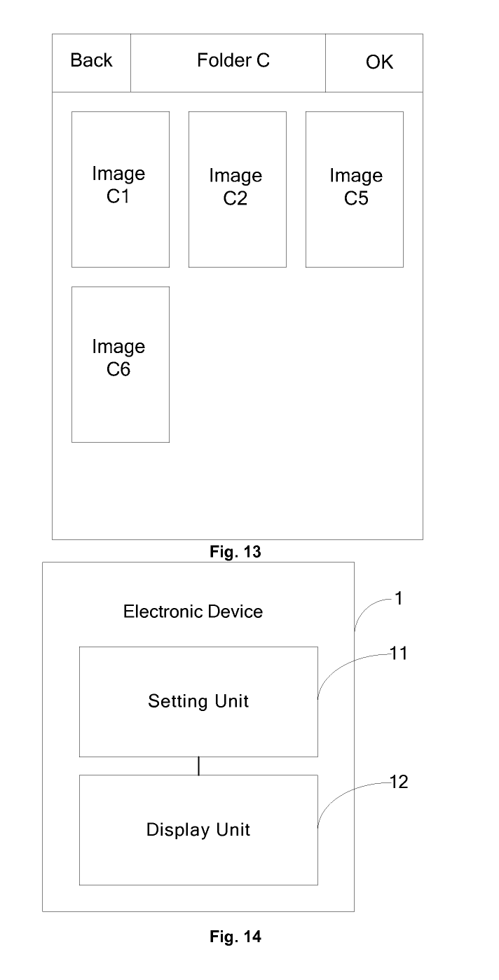

Meanwhile, in the image display system, the image files C1, C2, C5 and C6 in Folder C are displayed, and the image files C3 and C4 are not displayed, as shown in FIG. 13.

Alternatively, markers may be set for both a folder and a file in that folder. For example, the second marker may be set for Folder C, and the first marker may be set for each of the image files C1 and C2 in Folder C. In this case, the image files C1 and C2 in Folder C are displayed, while the remaining image files are not displayed based on the second marker set for Folder C.

Optionally, a step 303 may be performed following the step 302.

At 303, a marker edition instruction is received, and all the user data is displayed in response to the marker edition instruction, such that the user may reset the markers for all or part of the user data.

In an example, Folder A, Folder B, Folder C, Folder D and Folder E as well as the image files C1, C2, C3, C4, C5 and C6 in Folder C are displayed in response to the marker edition instruction.

Then, the user may reset the markers for all or part of the images files or folders.

The present disclosure provides the above information processing methods. The electronic device sets a marker for each user data and then displays each user data based on its marker. In this way, a filtering mechanism for user data is provided capable of filtering out any folder whose display is unnecessary. It is possible to address the inconvenience in data processing due to display of all the data, thereby improving user experience.

According to an embodiment of the present disclosure, an electronic device 1 is provided. The electronic device has M folders for storing multimedia files. As shown in FIG. 14, the electronic device includes the following units.

A setting unit 11 is configured to determine K folders satisfying a preset condition, and change a display property of each of the K folders, where M and K are non-negative integers and K<M.

A display unit 12 is configured to change, when at least one of the K folders is opened using a first application, a display policy for the at least one folder.

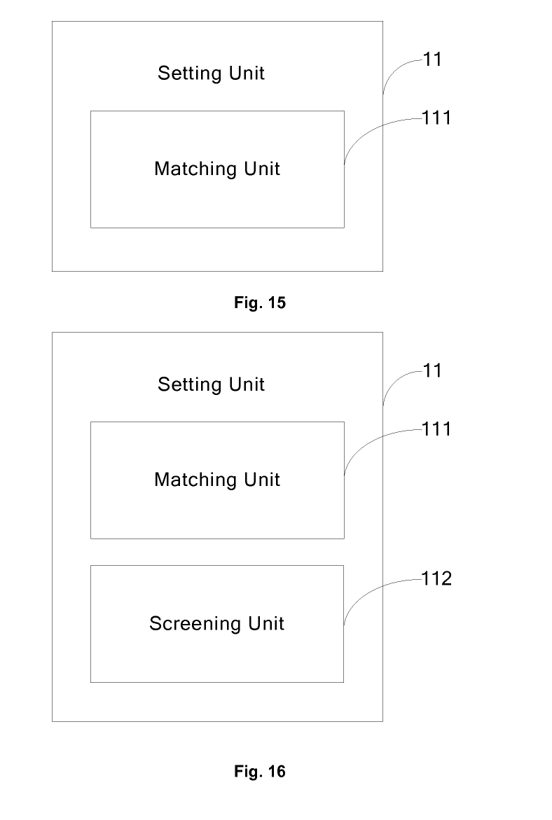

Optionally, as shown in FIG. 15, the setting unit 11 may include a matching unit 111 configured to obtain a name of each of the M folders, determine whether the name of each of the M folders contains a preset keyword, and determine one of the M folders as satisfying the preset condition if the name of the folder contains the preset keyword.

Optionally, as shown in FIG. 16, the setting unit 11 may include a screening unit 112 configured to: determine one of the M folders as satisfying the preset condition if the folder has a use frequency lower than a preset frequency threshold; determine one of the M folders as satisfying the preset condition if the folder is used, within a predetermined time period, for a number of times smaller than a preset number threshold; or determine one of the M folders as satisfying the preset condition if the folder is selected by a user operation to be non-display.

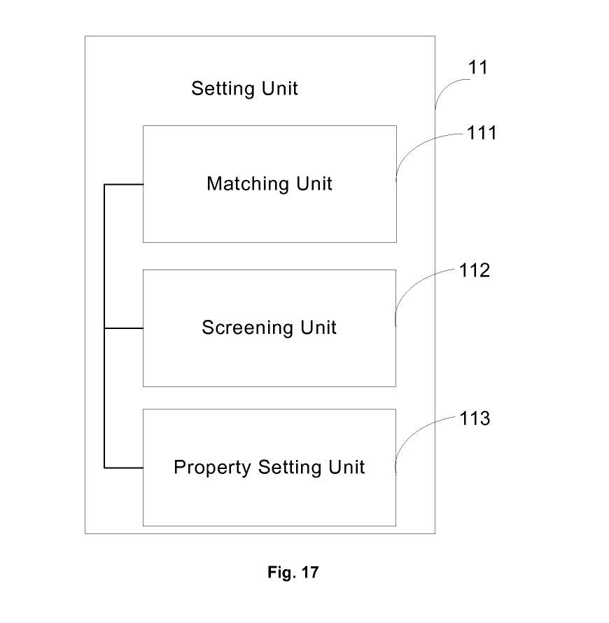

Optionally, as shown in FIG. 17, the setting unit 11 may include a property setting unit 113 configured to set the display property of each of the K folders as hidden, or set a chroma value in the display property of each of the K folders as a first chroma value.

Optionally, the display unit 12 is configured to, when the at least one of the K folders is opened using the first application, not display the at least one folder if the display property of the at least one folder is set as hidden, or display the at least one folder at the first chroma value if the chroma value in the display property of the at least one folder is set as the first chroma value.

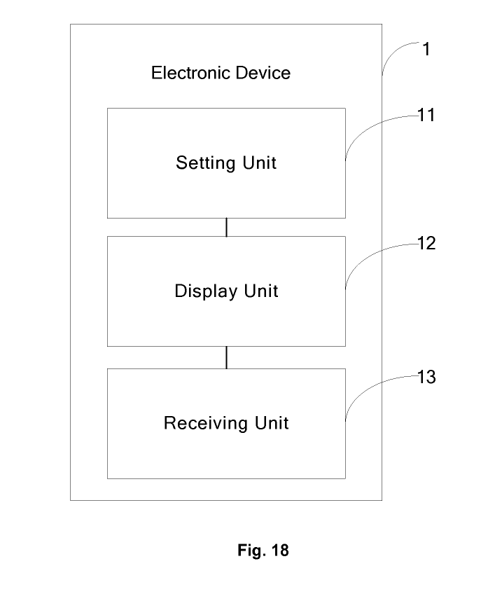

Optionally, as shown in FIG. 18, the electronic device 1 may further include a receiving unit 13 configured to receive a changing instruction from a user operation, and the display unit 12 is instructed to display all of the M folders.

The receiving unit 13 is further configured to receive a user instruction for resetting the display properties of N out of the M folders, and the setting unit 11 is instructed to reset the display property of each of the N folders.

The setting unit 11 is further configured to change, when the at least one of the N folders is opened using the first application, the display policy for the at least one folder based on the reset display property.

The present disclosure provides the above electronic devices. The electronic device determines K folders satisfying a preset condition and changes a display property of each of the K folders. When at least one of the K folders is opened using a first application, a display policy for the at least one folder is changed. In this way, a filtering mechanism for user data is provided capable of filtering out any folder whose display is unnecessary. It is thus possible to address the inconvenience in data processing due to display of all the data, thereby improving user experience.

It can be appreciated from the embodiments of the present application that the disclosed device and method can be implemented in alternative ways. The device embodiments as described above are illustrative only. For example, while the units have been divided in accordance with their logical functions, other divisions are possible in practice. For example, more than one unit or element can be combined or can be integrated into another system, or some features can be ignored or omitted. In addition, the coupling, direct coupling or communicative connection between various components as shown or discussed can be an indirect coupling or communicative connection via some interface, device or unit and can be electrical, mechanical or in another form.

The units described above as separated may or may not be physically separated. The components shown as units may or may not be physical units. They can be co-located or can be distributed over a number of network elements. Depending on actual requirements, some or all of the units can be selected to achieve the object of the present disclosure.

Further, all the functional units in various embodiments of the present disclosure can be integrated within one processing unit, or each of these units can be a separate unit, or two or more units can be integrated into one unit. Such integrated unit can be implemented in hardware, possibly in combination with software functional units.

The above integrated units implemented in the form of software functional units can be stored in a computer readable storage medium. These software functional units can be stored in a storage medium, which can be any of various mediums capable of storing program codes, such as a USB memory, a removable hard drive, a Read Only Memory (ROM), a Random Access Memory (RAM), a magnetic disk, an optical disc, containing instructions which cause a computer device (which can be a personal computer, a server, a network device or the like) to perform one or more methods according to the embodiments of the present application or particular parts thereof.

While the embodiments of the present disclosure have been described above, the scope of the present disclosure is not limited thereto. Various modifications and alternatives can be made by those skilled in the art without departing from the scope of the present disclosure. These modifications and alternatives are to be encompassed by the scope of the present disclosure which is only defined by the claims as attached.

What is claimed is:

1. An information processing method in an electronic device comprising a display unit and having M folders for storing multimedia files, the method comprising:
determining, from the M folders, K folders that satisfy a preset condition, and changing a display property of each of the K folders, wherein M and K are non-negative integers and K<M; and
when at least one of the K folders is opened using a first application, changing a display policy for the at least one folder.

2. The method of claim 1, wherein said determining K folders that satisfy a preset condition comprises:
obtaining a name of each of the M folders; and
determining whether the name of each of the M folders contains a preset keyword, and determining the folder as satisfying the preset condition if the name of the folder contains the preset keyword.

3. The method of claim 1, wherein said determining K folders that satisfy a preset condition comprises:
determining one of the M folders as satisfying the preset condition if the folder has a use frequency less than a preset frequency threshold; or
determining one of the M folders as satisfying the preset condition if the folder is used, within a predetermined time period, for a number of times less than a preset number threshold; or
determining one of the M folders as satisfying the preset condition if the folder is selected by a user operation to be non-display.

4. The method of claim 2, wherein said changing a display property of each of the K folders comprises:
setting the display property of each of the K folders as hidden; or
setting a chroma value in the display property of each of the K folders as a first chroma value.

5. The method of claim 3, wherein said changing a display property of each of the K folders comprises:
setting the display property of each of the K folders as hidden; or
setting a chroma value in the display property of each of the K folders as a first chroma value.

6. The method of claim 5, wherein said changing, when at least one of the K folders is opened using a first application, a display policy for the at least one folder comprises:
when the at least one of the K folders is opened using the first application, not displaying the at least one folder if the display property of the at least one folder is set as hidden; or
displaying the at least one folder at the first chroma value if the chroma value in the display property of the at least one folder is set as the first chroma value.

7. The method of claim 1, further comprising:
receiving a changing instruction from a user operation, and displaying all of the M folders;
receiving a user instruction for resetting the display properties of N folders from the M folders, and resetting the display property of each of the N folders, wherein N is non-negative integers and N<M; and
when the at least one of the N folders is opened using the first application, changing the display policy for the at least one folder based on the reset display property.

8. An electronic device having M folders for storing multimedia files, the electronic device comprising:
a setting unit configured to determine, from the M folders, K folders that satisfy a preset condition, and change a display property of each of the K folders, where M and K are non-negative integers and K<M; and
a display unit configured to change, when at least one of the K folders is opened using a first application, a display policy for the at least one folder.

9. The electronic device of claim 8, wherein the setting unit comprises a matching unit configured to:
obtain a name of each of the M folders; and
determine whether the name of each of the M folders contains a preset keyword, and determine the folder as satisfying the preset condition if the name of the folder contains the preset keyword.

10. The electronic device of claim 8, wherein the setting unit comprises a screening unit configured to:
determine one of the M folders as satisfying the preset condition if the folder has a use frequency less than a preset frequency threshold; or
determine one of the M folders as satisfying the preset condition if the folder is used, within a predetermined time period, for a number of times less than a preset number threshold; or
determine one of the M folders as satisfying the preset condition if the folder is selected by a user operation to be non-display.

11. The electronic device of claim 9, wherein the setting unit comprises a property setting unit configured to:
set the display property of each of the K folders as hidden; or
set a chroma value in the display property of each of the K folders as a first chroma value.

12. The electronic device of claim 10, wherein the setting unit comprises a property setting unit configured to:
set the display property of each of the K folders as hidden; or
set a chroma value in the display property of each of the K folders as a first chroma value.

13. The electronic device of claim 11, wherein the display unit is configured to:
when the at least one of the K folders is opened using the first application, not displaying the at least one folder if the display property of the at least one folder is set as hidden; or
display the at least one folder at the first chroma value if the chroma value in the display property of the at least one folder is set as the first chroma value.

14. The electronic device of claim 8, further comprising a receiving unit configured to receive a changing instruction from a user operation, and the display unit is instructed to display all of the M folders,
wherein the receiving unit is further configured to receive a user instruction for resetting the display properties of N folders from the M folders, and the setting unit is instructed to reset the display property of each of the N folders, wherein N is non-negative integers and N<M, and
wherein the setting unit is further configured to change, when the at least one of the N folders is opened using the first application, the display policy for the at least one folder based on the reset display property.
